(19) United States
(12) Patent Application Publication
(10) Pub. No.: US 2026/0086256 A1
(43) Pub. Date: Mar. 26, 2026

(54) SYSTEMS AND METHODS FOR ANALYZING UNCERTAINTY AND SENSITIVITY OF FAULT POPULATIONS

(71) Applicant: SCHLUMBERGER TECHNOLOGY CORPORATION, Sugar Land, TX (US)

(72) Inventor: Hilde Grude BORGOS, Stavanger (NO)

(21) Appl. No.: 19/112,252

(22) PCT Filed: Aug. 29, 2023
(86) PCT No.: PCT/US2023/031336

§ 371 Date: Mar. 16, 2025

Related U.S. Application Data
(60) Provisional application No. 63/375,772, filed on Sep. 15, 2022.

(51) Int. Cl. G01V 1/30

(52) U.S. Cl. CPC G01V 1/301; G01V 2210/642

(57) ABSTRACT

A method for determining an uncertainty of a representation of a fault population includes receiving seismic data representing a subterranean domain. The subterranean domain includes a plurality of faults. The method also includes generating a plurality of fault volumes based upon the seismic data. The method also includes generating a plurality of fault populations based upon the fault volumes. The fault populations are generated by extracting one or more fault objects from one or more of the fault volumes. The method also includes generating quantitative values based upon the fault populations. The quantitative values represent on or more of the fault objects, one or more of the fault populations, or both. The method also includes comparing the quantitative values to determine the uncertainty of the representation of the fault populations. The method also includes generating or updating a visual representation based upon the comparison.

### CROSS-REFERENCE TO RELATED APPLICATIONS

This application claims priority to U.S. Provisional Ser. No. 63/375,772, filed on Sep. 15, 2022, the entirety of which is incorporated by reference.

### BACKGROUND

A subsurface structural model including geological faults and layer boundaries can be constructed through workflows of analyzing 3D seismic measurements. Geological faults can be mapped in 3D from seismic measurements using signal analysis, machine-learning (ML), or artificial intelligence (AI). 3D fault volumes are then produced, with values indicative of the possible presence of a fault. Further, algorithms can be applied to extract and represent faults as separate objects in 3D, based on the fault volumes. In a workflow for characterizing the structural elements of the subsurface from seismic measurements, both the data measurements and each portion of the workflow are associated with uncertainty, which eventually produces an uncertainty in the final product.

### SUMMARY

A method for determining an uncertainty of a representation of a fault population is disclosed. The method includes receiving seismic data representing a subterranean domain. The subterranean domain includes a plurality of faults. The method also includes generating a plurality of fault volumes based upon the seismic data. Each of the fault volumes includes one or more of the faults. The method also includes generating a plurality of fault populations based upon the fault volumes. Each of the fault populations includes one or more of the faults. The fault populations are generated by extracting one or more fault objects from one or more of the fault volumes. The method also includes generating quantitative values based upon the fault populations. The quantitative values represent on or more of the fault objects, one or more of the fault populations, or both. The method also includes comparing the quantitative values to determine the uncertainty of the representation of the fault populations. The method also includes generating or updating a visual representation based upon the comparison.

A non-transitory, computer-readable medium is also disclosed. The medium storing instructions that, when executed by at least one processor of a computing system, cause the computing system to perform operations. The operations include receiving seismic data representing a subterranean domain. The subterranean domain includes a plurality of faults. The operations also include generating a plurality of fault volumes based upon the seismic data. Each of the fault volumes includes one or more of the faults. The operations also include generating a plurality of fault populations based upon the fault volumes. Each of the fault populations includes one or more of the faults. The fault populations are generated by: (1) extracting two or more different fault objects from one of the fault volumes, or (2) extracting a first one of the fault objects from a first one of the fault volumes, and extracting a second one of the fault objects from a second one of the fault volumes. The operations also include generating quantitative values based upon the fault populations. The quantitative values represent one or more of the fault objects, one or more of the fault populations, or both. The quantitative values include numeric measures of the fault populations, geometric measures of the fault objects, topologic measures of the fault objects and the fault populations, seismic amplitudes at locations of the fault objects, an image analysis of the seismic amplitudes at the locations of the fault objects, or a combination thereof. The operations also include comparing the quantitative values to determine an uncertainty of a representation of the fault populations. Comparing the quantitative values includes generating or updating a visual representation of the quantitative values. The operations also include displaying the visual representation on a display.

A computing system is also disclosed. The computing system includes one or more processors and a memory system coupled to the one or more processors. The memory system includes one or more non-transitory computer-readable media storing instructions that, when executed by at least one of the one or more processors, cause the computing system to perform operations. The operations include receiving seismic data representing a subterranean domain. The subterranean domain includes a plurality of faults. The operations also include generating a plurality of fault volumes based upon the seismic data. Each of the fault volumes includes one or more of the faults. Each of the fault volumes is generated using a machine learning (ML) model or using an image analysis technique. The operations also include generating a plurality of fault populations based upon the fault volumes. Each of the fault populations includes one or more of the faults. The fault populations are generated by (1) extracting two or more different fault objects from one of the fault volumes, or (2) extracting a first one of the fault objects from a first one of the fault volumes, and extracting a second one of the fault objects from a second one of the fault volumes. Each fault object represents a corresponding one of the faults as a set of points from the fault volume in three dimensions. The fault objects are extracted after varying one or more parameters. The operations also include generating quantitative values based upon the fault populations. The quantitative values represent one or more of the fault objects, one or more of the fault populations, or both. The quantitative values include numeric measures of the fault populations, geometric measures of the fault objects, topologic measures of the fault objects and the fault populations, seismic amplitudes at locations of the fault objects, image analysis of the seismic amplitudes at the locations of the fault objects, or a combination thereof. The operations also include comparing the quantitative values to determine an uncertainty of a representation of the fault populations. Comparing the quantitative values includes generating or updating a visual representation of the quantitative values. The operations also include displaying the visual representation on a display. The operations also include building or updating a model of the subterranean domain based upon the uncertainty.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a workflow to generate a subsurface structural model from an input data volume by applying a series of parameterized operators, according to an embodiment.

FIG. 5 illustrates the workflow of FIG. 4, in the case where input is a machine-learning (ML) fault prediction volume and two operators are applied; the first one extracting faults from the prediction volume and producing a points set in 3D for each fault; the second taking the 3D point sets into an operator for building a fault framework and producing a set of triangulated fault surfaces, according to an embodiment.

FIG. 6 illustrates a flow diagram of the workflow, according to an embodiment.

FIG. 7 illustrates a workflow execution on multiple input ML fault prediction volumes, using the same parameterization of the algorithms, according to an embodiment.

FIG. 8 illustrates a workflow execution on a single ML fault prediction volume, perturbing the fault extraction parameters while using the same parameters in the fault framework building in the executions, according to an embodiment.

FIG. 9 illustrates a workflow execution on a single ML fault prediction volume, perturbing the fault framework building parameters while using the same parameters in the fault extraction in the executions, according to an embodiment.

FIG. 10 illustrates a fault size distribution plot, with data points representing realizations generated by perturbing a parameter, and thus depicting how a perturbed parameter may influence the total number of extracted faults and their sizes, according to an embodiment.

FIGS. 11A-11C illustrate a fracture network in 2D (FIG. 11A), classification of fracture branch end points into node types (FIG. 11B) with digitized representation on a 2D regularly sampled grid (FIG. 11C), according to an embodiment.

FIG. 12 illustrates a ternary plot showing the proportions of I-, Y- and X-nodes of a fracture network with a large proportion of crossing fractures, according to an embodiment.

FIGS. 13A-13C illustrate a 3D image (FIG. 13A), a shallow 2D intersection image (FIG. 13B), and a deep 2D intersection (FIG. 13C), each including an I-node, a Y-node, and/or an X-node, according to an embodiment.

FIG. 14 illustrates a graph showing a proportion of I-nodes per depth, calculated in horizontal 2D intersections through the fault population. The data points are generated by perturbing a parameter, illustrating in this case how a perturbed parameter influences the proportion of isolated nodes and hence connectivity per depth, according to an embodiment.

FIG. 15 illustrates a flowchart of a method for analyzing uncertainty and/or sensitivity of a fault population, according to an embodiment.

FIGS. 16A and 16B illustrate schematic perspective views of different fault volumes of the same subterranean domain, according to an embodiment.

FIG. 17 illustrates a schematic perspective view of a fault population including a plurality of fault objects, according to an embodiment.

FIG. 18 illustrates a schematic view of a fault object represented as a set of points, according to an embodiment.

FIG. 19 illustrates a schematic perspective view showing a relationship between the first cutoff threshold and the fault volume values, according to an embodiment.

FIG. 20 illustrates a schematic view of a computing system for performing at least a portion of the method(s) described herein, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

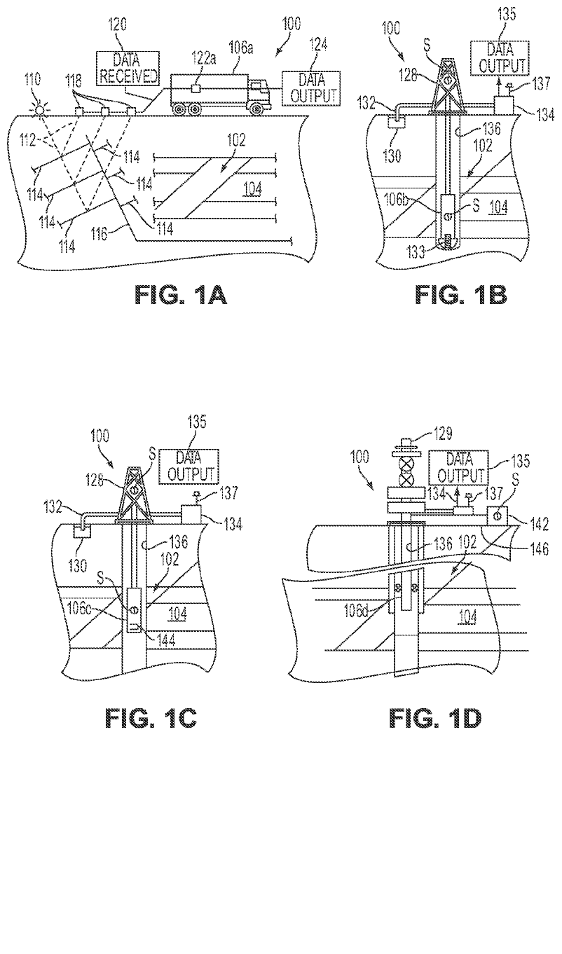

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102. Sensors (S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

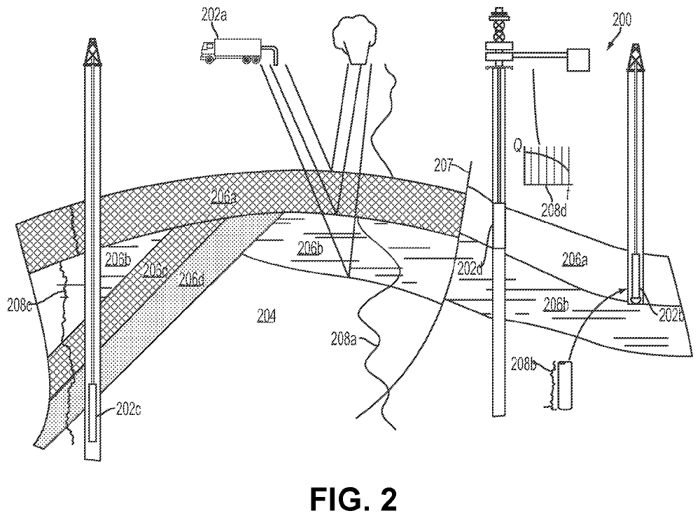

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

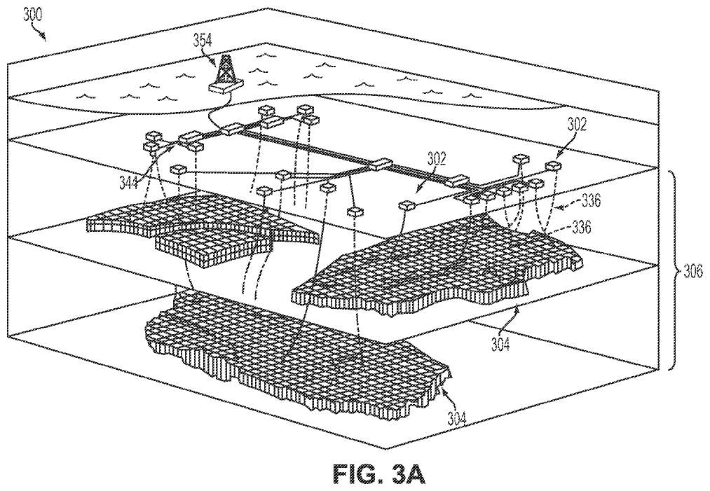

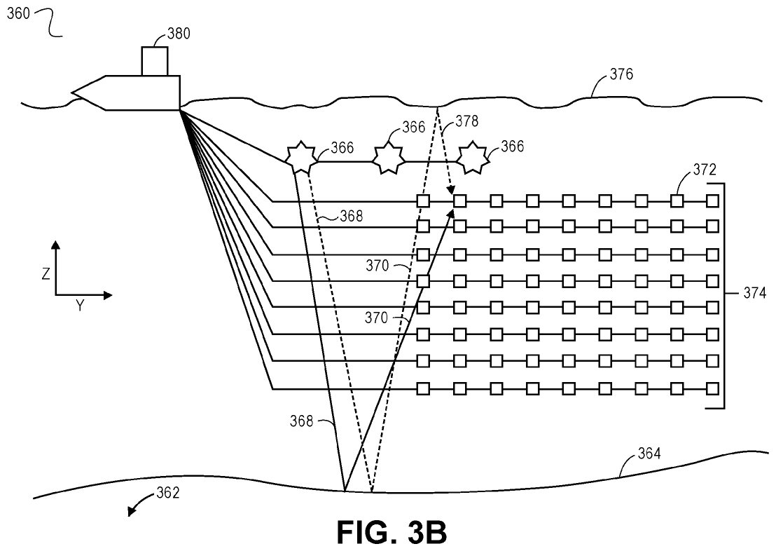

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Embodiments of the present disclosure provide an uncertainty and sensitivity analysis for results of processes associated with automatically extracting and representing populations of geological faults, assuming input data is available as 3D fault volumes generated from seismic measurements. As used herein, “uncertainty” refers to imperfect or unknown information about the true underlying population of geological faults when automatically extracted by the process. As used herein, “sensitivity” refers to uncertainty of the extracted populations of geological faults allocated to different sources of uncertainty in the inputs to the process. As used herein, a “fault volume” refers to three-dimensional data derived from seismic data, where the values of the data are indicative of the presence of geological faults.

At least some embodiments provide methods for generating multiple realizations of fault populations either from different input volumes (e.g., different ML-trained models or different seismic fault attributes), or from different parameterizations in the automation steps of extracting single fault objects and building a structural fault framework. As used herein, a “fault population” refers to a plurality of individual fault objects. Methods for comparing the different fault populations are also presented, achieved through calculating quantities describing the fault population (e.g., through fault size distributions) and measures of fault connectivity (e.g., as illustrated through a variety of plots). Certain embodiments may be applied within a larger system of automation.

Input data and/or each portion of a workflow for building a structural model of a subsurface are associated with uncertainty. For example, there may be an inherent uncertainty in the input data; further, each method or operator of a workstep may add uncertainty through a model assumption with associated parameterization. A method for analysis of fault populations produced by such a workflow is disclosed herein, which provides a quantitative and illustrative comparison of multiple subsurface structural model realizations generated by repeated applications of the workflow.

Multiple realizations can be generated in several ways. One example is fault populations resulting from different input fault volumes, such as generated using the same parameterization of the operators of the worksteps. The analysis may be used for comparison of competing input fault volumes (e.g., different ML predictions or seismic attribute volumes). Another example is fault populations resulting from different parameterizations of an operator in a workstep (e.g., each acting on the same input data). The analysis of the present methods may, in such case, be used for quantification of the sensitivity to the individual parameters of the operator.

Fault populations can be compared quantitatively or visually through statistics of individual faults or of the overall fault populations. Plots representing such statistics include histograms or fault size distribution plots. Another measure is fault connectivity, which may influence the compartmentalization and hence the conditions for fluid flow in a reservoir. By quantifying the connectivity of a fault population, a metric is obtained for comparing different fault populations. Using multiple outcomes of the structural modelling workflow, the variability or uncertainty in overall connectivity can be analyzed.

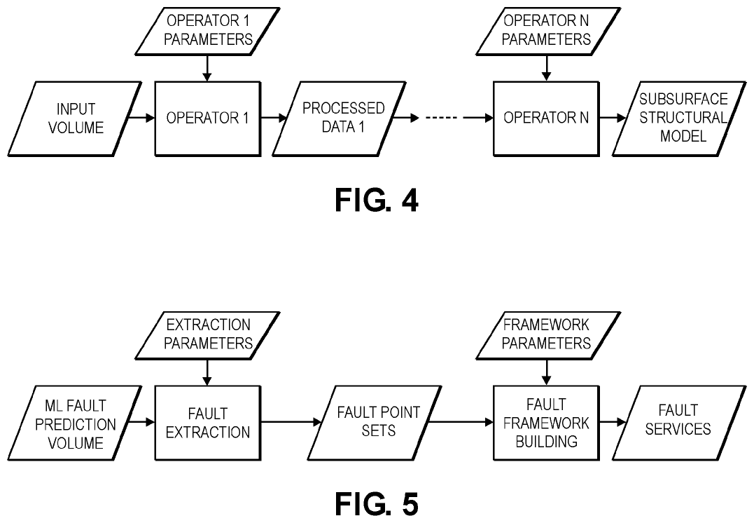

The uncertainty and sensitivity analysis may be associated with a workflow for building a subsurface structural model from seismic data. FIG. 4 illustrates a workflow to generate a subsurface structural model from an input data volume by applying a series of parameterized operators, according to an embodiment. FIG. 4 starts with an input data volume, and applies several parameterized operators to produce a subsurface structural model. The input data volume may be derived from a seismic volume (e.g., as seismic attributes) or an ML prediction volume derived from seismic data and a trained ML model. The output subsurface structural model gives a geometric representation of the surfaces and faults of the subsurface (e.g., represented as gridded or triangulated surfaces, or a set of coordinates in 3D).

FIG. 5 illustrates the workflow of FIG. 4, in the case where input is a ML fault prediction volume and two operators are applied. The first operator extracts faults from the prediction volume and producing a point set in 3D for each fault. The second operator takes the 3D point sets into an operator for building a fault framework and producing a set of triangulated fault surfaces. Two algorithms may be applied (e.g., stepwise) to produce a set of fault surfaces representing the fault framework of the structural model. First, individual faults may be extracted from the ML fault prediction volume and represented as point sets of (X, Y, Z) coordinates in 3D. Second, the point sets of each individual fault are converted into triangulated surfaces, and intersections between faults are detected and modified to produce a geologically consistent fault framework.

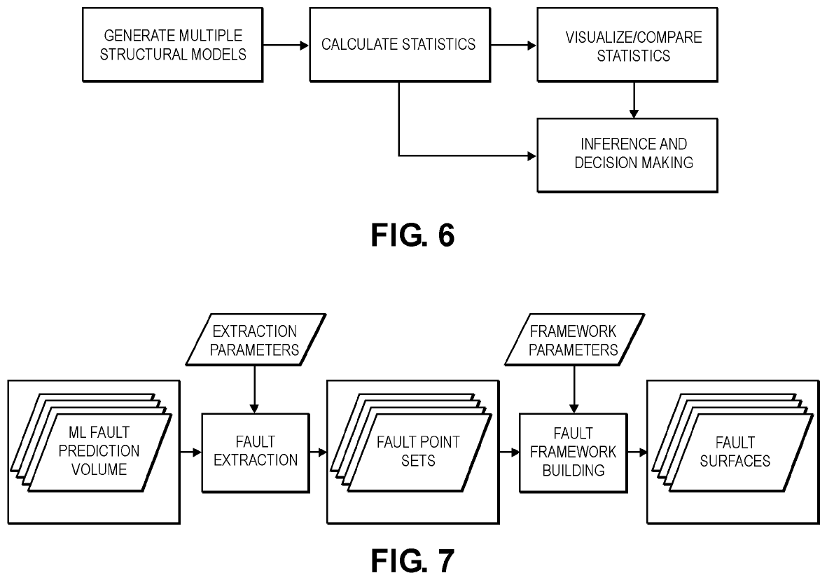

FIG. 6 illustrates that the uncertainty and sensitivity analysis may be obtained through the generation of multiple different structural models from the suggested workflow, followed by the calculation of statistics representing the generated models, and finally a visualization or comparison of the quantities. The calculated statistics, with supporting visualizations, can be applied to make inference and take decisions (e.g., regarding choice of input and parameter values) or creation of multiple scenarios for further analysis.

### Multiple Realization Generation

Variability in the produced subsurface structural model in FIG. 4, represented by fault surfaces in FIG. 5, can be explored by multiple executions of the workflow through random or specified perturbations of input or parameters. Multiple realizations of the structural model can be constructed in numerous ways. FIG. 7 illustrates an example of how the workflow of how FIG. 5 can be repeatedly executed using multiple input volumes, applying the same parameters of the operators of the workflow in the individual runs. This produces a separate subsurface structural model for each input volume.

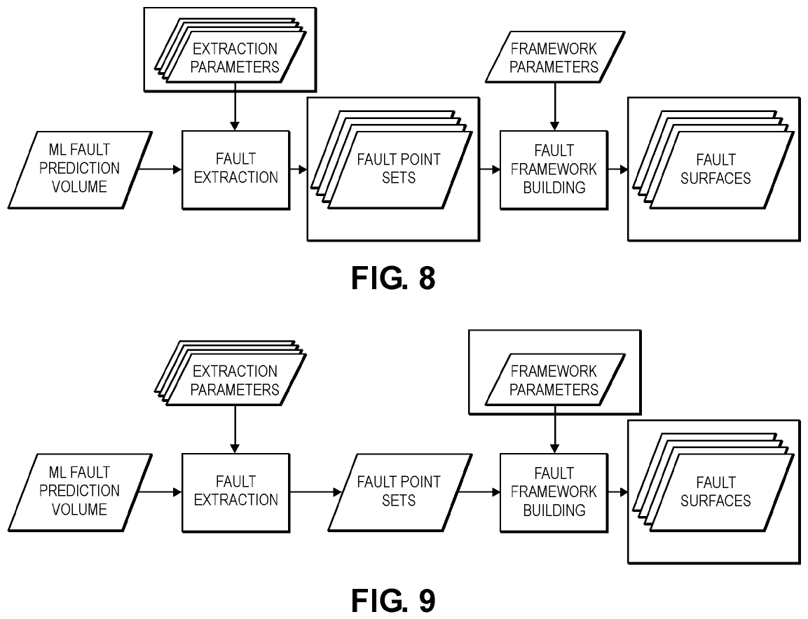

Some other ways of generating multiple input volumes from a single seismic dataset include: different ML prediction volumes obtained from the same seismic data, but using ML models trained on different training data, different ML prediction volumes obtained from the same seismic data, but using ML models trained using different ML algorithms or designs, and/or different seismic attribute volumes calculated on the same seismic data FIG. 8 and FIG. 9 illustrate examples of how the workflow of FIG. 5 may be repeatedly executed on a single input volume, applying perturbed values of the parameters of either of the operators in each run. This produces a separate subsurface structural model for each parameter perturbation. The concept may be generalized further by perturbing parameters of several operators in each workflow execution.

Another way of generating multiple parameter values includes a deterministic definition of perturbations, such as user specification of multiple values of a single parameter of a single operator, user specification of multiple values of several parameters of a single operator, and/or user specification of multiple values of several parameters of several operators. Further, the multiple parameter values may be generated by random perturbations from statistical distributions of parameters (e.g., Monte Carlo sampling or Latin Hypercubes), such as random generation of multiple values of a single parameter of a single operator, random generation of multiple values of several parameters of a single operator, and/or random generation of multiple values of several parameters of several operators.

Calculation and visualization of characteristics of a structural model Each generated structural model resulting from repeated execution of the workflow in FIG. 4 may contain a large number of objects (e.g., faults and/or horizons), making a visual comparison of multiple realizations of the model challenging. Instead, statistics capturing characteristics of a subsurface structural model can be calculated to compare multiple realizations. For the workflow of FIG. 5, single faults may be characterized by their size (e.g., area, height, width) or orientation (e.g., strike, azimuth), while interactions between faults may be characterized through measures of connectivity. Such fault population statistics can be calculated either on the fault point sets generated by the fault extraction or the subsequent fault surfaces generated by the fault framework building step in FIG. 5.

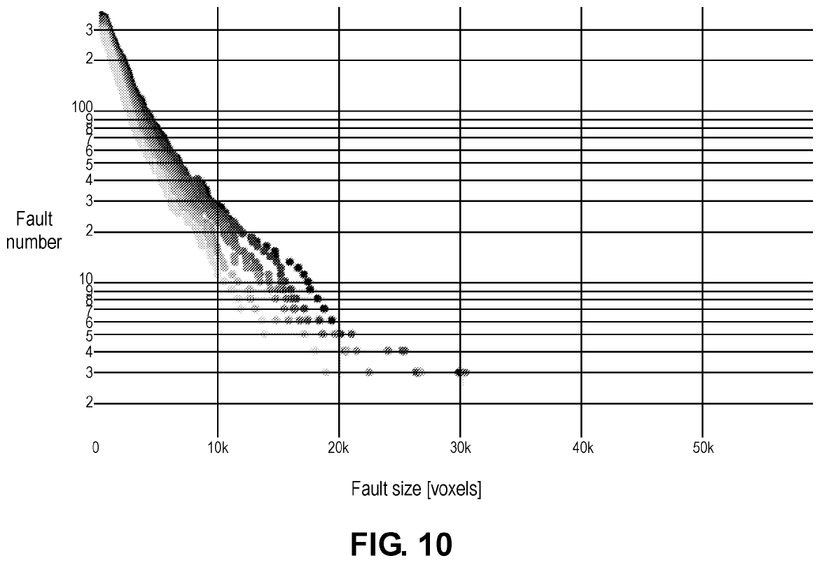

Fault size distributions, in some examples, are illustrated through histograms, or through size distribution plots obtained by sorting the faults according to size and plotting as a function of sort order (FIG. 10). Multiple realizations are compared by including the fault size distribution of the different realizations in the same plot. In FIG. 10, each of different shades of the dots represent the fault size distribution of different parameterizations of the fault extraction algorithm; the darker dots represent fault size distribution with a parameterization containing a low threshold for when to consider a fault volume value to be indicative of the presence of a fault, and the lighter dots represent fault size distribution with a parameterization containing a high threshold for when to consider a fault volume value to be indicative of the presence of a fault.

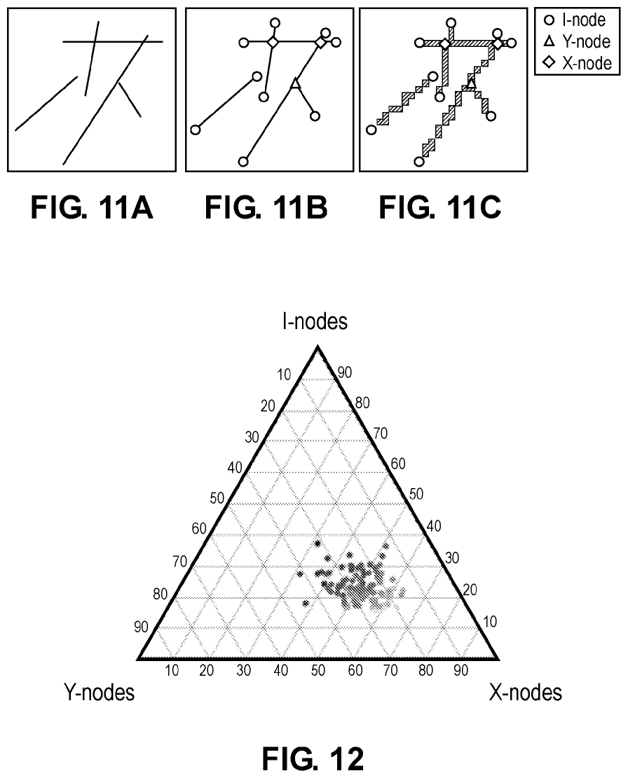

Fault or fracture connectivity in 2D, in some examples, may be explored using a topology analysis. Each fracture in the 2D fracture network may be split up into branches, and each end point of a fracture branch may be referred to as a node in the fracture network and classified as isolated (I-node), abutting against another fracture (Y-node) or crossing another fracture (X-node) (FIGS. 11A-11C). Nodes in a 2D fracture network may be identified on a continuous representation of the fracture lines (FIG. 11B) or on a digitized version (FIG. 11C). A fracture network topology is represented through the proportion of the three node types. Different fracture networks can be compared visually using these three proportions (e.g., in a ternary plot where the three corners represent 100% of either of the three node types) (FIG. 12). In FIG. 12, the darker dots represent fracture network topologies with a smaller total number of nodes per area, and the lighter dots represent fracture network topologies with a higher total number of nodes per area.

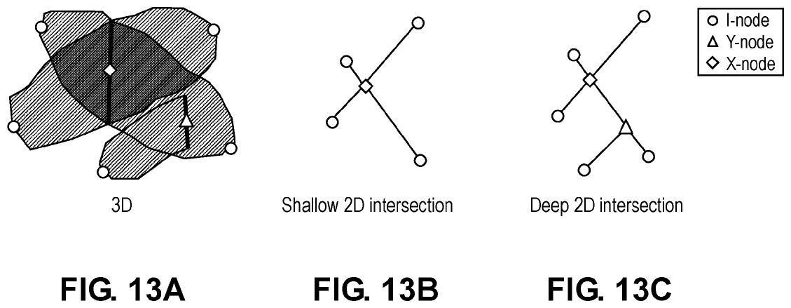

FIGS. 13A-13C illustrate a 3D image (FIG. 13A), a shallow 2D intersection image (FIG. 13B), and a deep 2D intersection (FIG. 13C), each including an I-node, a Y-node, and/or an X-node, according to an embodiment. More particularly, an adaption of the 2D topology analysis to 3D fault networks may be obtained by generalizing the concept of I-, Y- and X-nodes to 3D. Fault branching may not be defined in 3D as easily as it is in 2D, since an intersection between two faults may not expand totally across both faults. Considering the entire fault instead of fault branches, each fault in 3D may possess one, two, or three node types: I-nodes representing isolated sections of the boundary of the fault; Y-nodes internally or along the boundary; and X-nodes internally in the fault surface. Y-nodes and X-nodes are shared between a pair of faults, following the intersection between the two. Completely isolated faults are identified as faults containing I-nodes and no other types of nodes, while any fault mainly connected to other faults along its entire boundary is identified by having few or no I-node sections along the boundary.

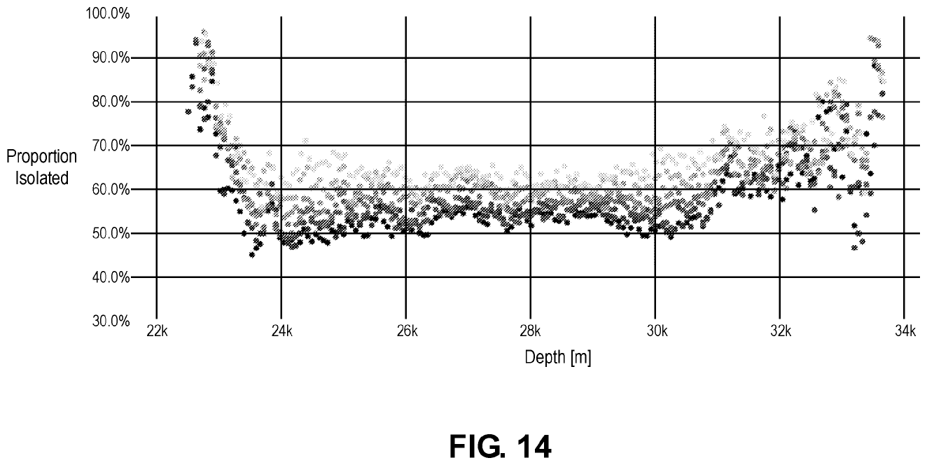

A 3D fault network topology analysis may also be generated as a set of 2D analyses in densely sampled horizontal 2D intersections through a fault population in 3D. This enables the analysis of topology as a function of depth or aggregated over multiple depths. A topology analysis as a function of depth, performed on multiple realizations, captures vertical changes in topology throughout different fault populations (FIG. 14). In FIG. 14, each of different shades of the dots represent the fault size distribution of different parameterizations of the fault extraction algorithm; the darker dots represent fault size distribution with a parameterization containing a low threshold for when to consider a fault volume value to be indicative of the presence of a fault, and the lighter dots represent fault size distribution with a parameterization containing a high threshold for when to consider a fault volume value to be indicative of the presence of a fault. Aggregated over multiple depths, an overall 3D topology may be obtained by calculating the proportions of different 2D node types throughout multiple horizontal 2D intersections.

### Inference and Decision Making

Depending on the design of the multiple realizations, different inference and decisions may be made. In some examples, the workflow executed on different input volumes generates a set of different subsurface structural models. A comparison of statistics and calculated characteristics of the different structural models can help in decision making regarding the preferred input volume(s). A value of a single parameter to one of the operators in the workflow may be perturbed, which may permit an analysis of the sensitivity in the system to this specific parameter, for a single input volume, according to some examples. The result of the sensitivity analysis, in some examples, may guide a user of the system in selection of parameter values and identification of parameters with little influence on the overall variability and uncertainty of the generated structural framework. Further, random perturbations of one or many parameters of the operators in the workflow, followed by calculation of statistics, may enable statistical distributions of the characteristics of the structural model, for a single input volume. This, in turn, equips the user of the system with knowledge on the overall uncertainty of the generated structural framework related to the workflow operators. The analysis generates a set of quantities for inference and decision making, but also the level of perceived compartmentalization can act as a metric in decision making, when evaluated by a user of the system.

### Further Generalizations

Referring again to FIG. 4 and FIG. 6, a general workflow is shown for subsurface structural model building and comparisons of multiple realizations generated through repeated execution of the workflow. These examples are related to the specifics of building and analyzing a fault framework, but the workflows of FIG. 4 and FIG. 6, for some examples, are generalized to other worksteps in the overall subsurface structural model building. For example, geological layer boundaries may be expressed as seismic horizons, and are mapped and extracted using machine learning or signal analysis for identifying horizon positions followed by operators for obtaining a geometric representation of the surface. Variability and uncertainty in structural layers, for instance, are quantified through measures of volume between different layer boundaries.

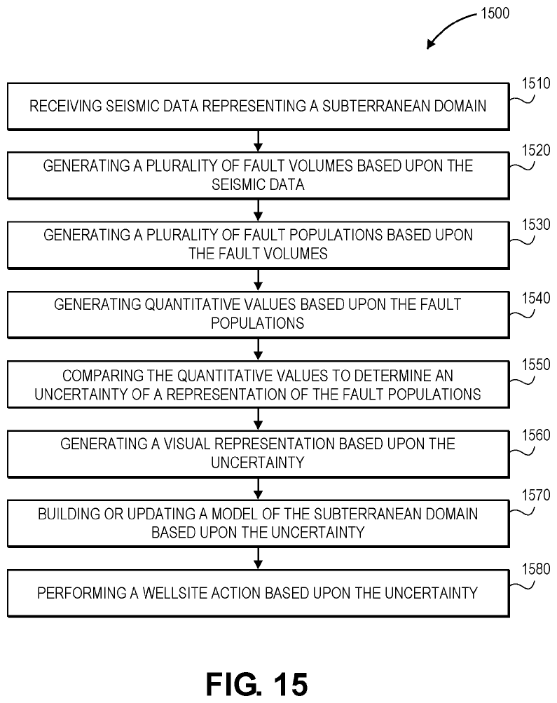

FIG. 15 illustrates a flowchart of a method 1500 for analyzing uncertainty and/or sensitivity of a fault population, according to an embodiment. An illustrative order of the method 1500 is provided below; however, one or more portions of the method 1500 may be performed in a different order, simultaneously, repeated, or omitted.

The method 1500 may include receiving seismic data representing a subterranean domain, as at 1510. The subterranean domain may include a plurality of faults.

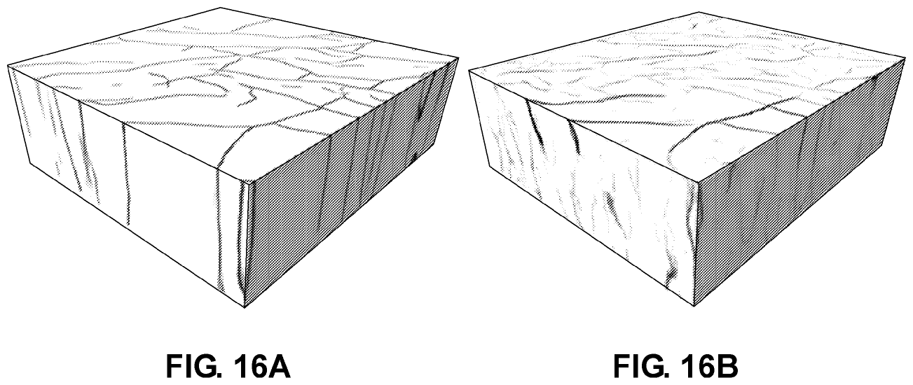

The method 1500 may also include generating a plurality of fault volumes based upon the seismic data, as at 1520. FIGS. 16A and 16B illustrate schematic perspective views of different fault volumes of the same subterranean domain, according to an embodiment. In FIGS. 16A and 16B, the faults are represented by the lines. One or more (e.g., each) of the fault volumes may include one or more of the faults. In one embodiment, the fault volumes may at least partially overlap. In another embodiment, the fault volumes may not overlap. Each of the fault volumes may be generated using a ML model or using an image analysis technique. In an embodiment, each of the fault volumes may be generated using a different ML model or a different image analysis technique.

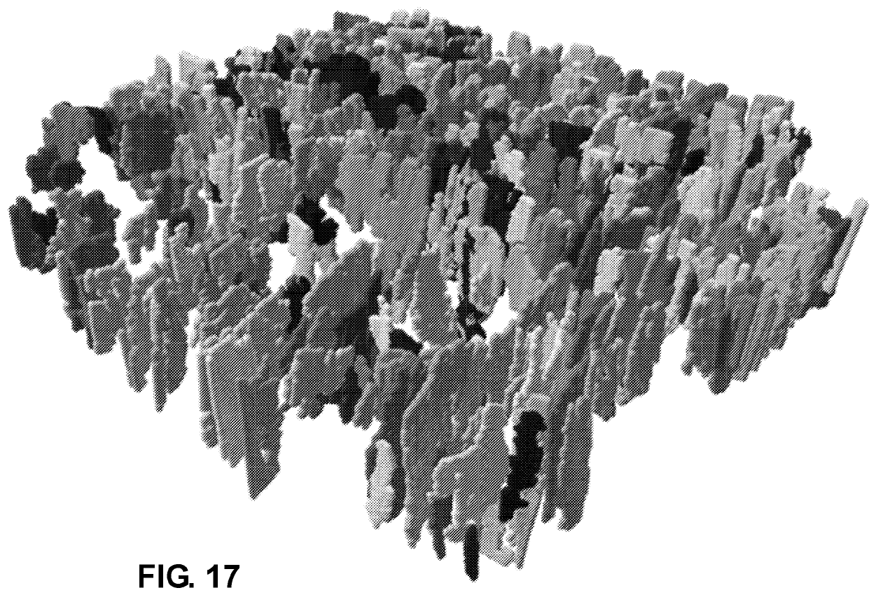

The method 1500 may also include generating a plurality of fault populations based upon the fault volumes, as at 1530. Each of the fault populations may include one or more of the faults, one or more of the fault volumes, or a combination thereof. In one embodiment, the fault populations may be generated by extracting two or more different fault objects from one of the fault volumes. In another embodiment, the fault populations may also or instead be generated by extracting a first one of the fault objects from a first one of the fault volumes, extracting a second one of the fault objects from a second one of the fault volumes, and so on. FIG. 17 illustrates a schematic perspective view of a fault population including a plurality of fault objects, according to an embodiment.

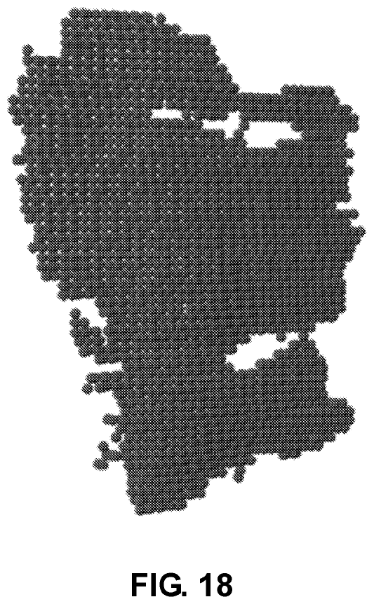

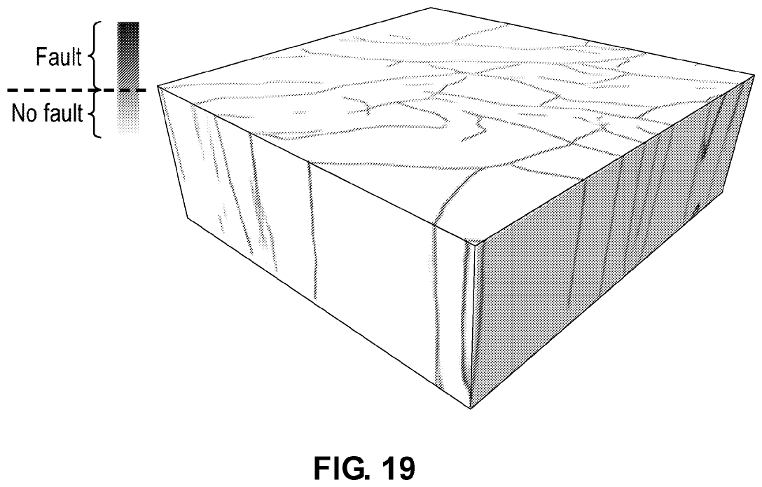

FIG. 18 illustrates a schematic view of a fault object represented as a set of points (e.g., X, Y, Z coordinates), according to an embodiment. More particularly, each fault object represents a corresponding one of the faults as a set of points (e.g., X, Y, Z coordinates) from the fault volume in three dimensions. The fault objects may be extracted after varying one or more parameters. The parameters may include a first cutoff threshold of fault volume values, above which a point is determined to be a point of one of the fault objects, and below which the point is determined not to be a point of one of the fault objects. FIG. 19 illustrates a schematic perspective view showing a relationship between the first cutoff threshold and the fault volume values, according to an embodiment. In FIG. 19, darker shading indicates faults, and lighter shading does not. The parameters may also or instead include a radius and a second cutoff threshold of planarity for which (1) a first plurality of points separated by a distance within the radius, that are aligned along a surface of planarity above the second cutoff threshold, are determined to be part of the same fault object, and (2) a second plurality of points separated by the distance within the radius, that are not aligned along a surface of planarity above the second cutoff threshold, are determined not to be part of the same fault objects. The parameters may also or instead include a lower cutoff angle and an upper cutoff angle for which fault objects of direction angles between the two cutoff angles are extracted. The parameters may also or instead include a sector angle and an overlap angle for which overlapping angular sections are defined within a range of angles between a lower cutoff angle and an upper cutoff angle, and fault objects are extracted separately within each of the overlapping angular sections.

The method 1500 may also include generating quantitative values based upon the fault populations, as at 1540. The quantitative values represent one or more of the fault objects, one or more of the fault populations, or both. The quantitative values may include numeric measures of the fault populations, geometric measures of the fault objects, topologic measures of the fault objects and the fault populations, seismic amplitudes at locations of the fault objects, image analysis of the seismic amplitudes at the locations of the fault objects, or a combination thereof. The numeric measures may be or include a (e.g., total) number of the fault objects in each fault population. The geometric measures may be or include sizes of the fault objects. The geometric measures may also or instead be or include directions of the fault objects. The directions of the fault objects may be represented by a first angle describing a vertical dip of the fault object and/or a second angle describing a horizontal orientation of the fault object. The geometric measures may also or instead be or include shapes of the fault objects. The topologic measures may be or include a connectivity between two or more of the fault objects. The seismic amplitudes may be or include values of the seismic data along one or more of the fault objects. The image analysis may be or include values calculated based upon the seismic data gathered along one or more of the fault objects. A confidence of the ML model may be calculated based upon the seismic data.

The method 1500 may also include comparing the quantitative values to determine an uncertainty of a representation of the fault populations, as at 1550. Comparing the quantitative values may include generating or updating a visual representation of the quantitative values. The representation of the fault populations is the set of fault objects that have been extracted (e.g., the coordinates of the faults in the fault population. The uncertainty of the fault extraction process is represented through the quantitative measures that has been calculated, where the visual representation is used to visualize the variability in the numeric quantities, not the single fault objects. Generating the visual representation may include generating a spreadsheet including the quantitative values. Generating the visual representation may also or instead include plotting the quantitative values for each of the fault populations on a different plot, and then comparing the plots. Generating the visual representation may also or instead include plotting the quantitative numbers for different ones of the fault populations on a single plot.

The method 1500 may also include displaying the visual representation on a display, as at 1560. The display may be part of a computer, smartphone, tablet, etc.

The method 1500 may also include building or updating a model of the subterranean domain based upon the uncertainty, as at 1570. In one embodiment, the model in 1570 may be the same as the model in 1520. In another embodiment, the model in 1570 may be or include a selected (e.g., optimal) fault population, or a set of fault populations spanning the range of variability. Simultaneously with or after the (e.g., fault) model is being built or updated, the full structural part of the model may also incorporate horizons, salt bodies, and other objects, and the complete subterranean model may also contain rock properties that influence fluid flow.

The method 1500 may also include performing a wellsite action, as at 1580. The wellsite action may be performed based upon the uncertainty of the representation of the fault populations. The wellsite action may be or include generating and/or transmitting a signal (e.g., using a computing system) that causes a physical action to occur at a wellsite. The wellsite action may also or instead include performing the physical action at the wellsite. The physical action may be or include varying a weight and/or torque on a drill bit, varying a drilling trajectory, varying a concentration and/or flow rate of a fluid pumped into a wellbore, or the like.

Embodiments of the present disclosure may help the user to better understand aspects of uncertainty of the automatically generated structural model, choose between alternative inputs (e.g., ML predictions or seismic attributes), make decisions on parameterization in the automation, and select different structural model scenarios for further analysis. The uncertainty and parameter sensitivity of the structural model, in some examples, may be linked to further worksteps towards reservoir property modelling and flow simulation (e.g., through selection of multiple structural model scenarios).

In one or more embodiments, the functions described are implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

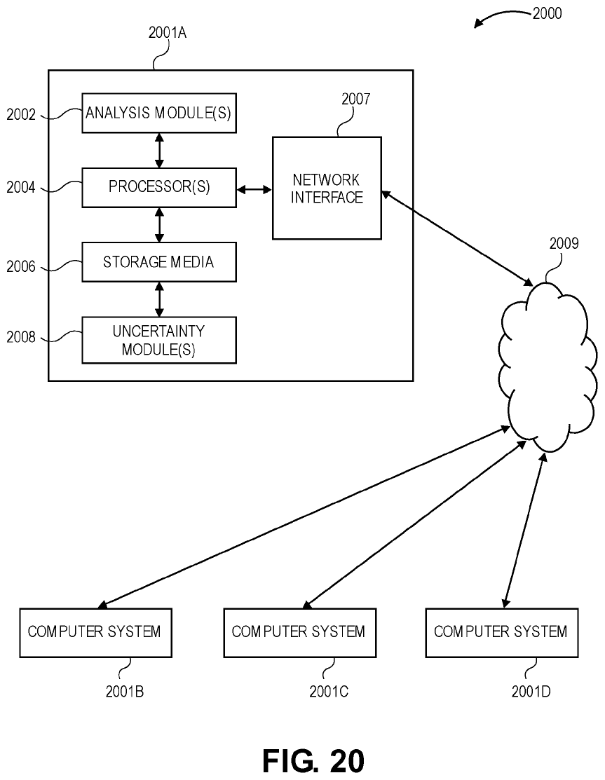

In some examples, any of the methods of the present disclosure may be executed using a system, such as a computing system. FIG. 20 illustrates an example of such a computing system 2000, in accordance with some examples. The computing system 2000 may include a computer or computer system 2001a, which may be an individual computer system 2001a or an arrangement of distributed computer systems. The computer system 2001a includes one or more analysis module(s) 2002 configured to perform various tasks according to some embodiments, such as one or more methods disclosed herein. To perform these various tasks, the analysis module 2002 executes independently, or in coordination with, one or more processors 2004, which is (or are) connected to one or more storage media 2006. The processor(s) 2004 is (or are) also connected to a network interface 2007 to allow the computer system 2001a to communicate over a data network 2009 with one or more additional computer systems and/or computing systems, such as 701b, 2001c, and/or 2001d (note that computer systems 2001b, 2001c and/or 2001d may or may not share the same architecture as computer system 2001a, and may be located in different physical locations, e.g., computer systems 2001a and 2001b may be located in a processing facility, while in communication with one or more computer systems such as 2001c and/or 2001d that are located in one or more data centers, and/or located in varying countries on different continents).

A processor can include a microprocessor, microcontroller, processor module or subsystem, programmable integrated circuit, programmable gate array, or another control or computing device.

The storage media 2006 can be implemented as one or more computer-readable or machine-readable storage media. Note that while in the example embodiment of FIG. 20 storage media 2006 is depicted as within computer system 2001a, in some embodiments, storage media 2006 may be distributed within and/or across multiple internal and/or external enclosures of computing system 2001a and/or additional computing systems. Storage media 2006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 2000 contains one or more uncertainty module(s) 2008. In the example of computing system 2000, computer system 2001a includes the uncertainty module 2008. In some embodiments, a single uncertainty module 2008 may be used to perform some or all aspects of one or more embodiments of the methods. In alternate embodiments, a plurality of uncertainty modules 2008 may be used to perform some or all aspects of methods.

It should be appreciated that computing system 2000 is only one example of a computing system, and that computing system 2000 may have more or fewer components than shown, may combine additional components not depicted in the example embodiment of FIG. 20, and/or computing system 2000 may have a different configuration or arrangement of the components depicted in FIG. 20. The various components shown in FIG. 20 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 2000, FIG. 20), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

Embodiments of the present disclosure may be adapted for and integrated into a variety of practical applications, such as, for example, visualizing fault networks, which may facilitate exploration, drilling, completion, and/or other personnel making informed decisions about well trajectories, intervention/treatment parameters, and/or other equipment parameters. Further, in at least some embodiments, the generation of the fault networks may be used in a more automated fashion to permit automatic control/adjustment of equipment parameters, equipment selection, and/or the like.

What is claimed is:

1. A method for determining an uncertainty of a representation of a fault population, the method comprising:
receiving seismic data representing a subterranean domain, the subterranean domain includes a plurality of faults;
generating a plurality of fault volumes based upon the seismic data, each of the fault volumes includes one or more of the faults;
generating a plurality of fault populations based upon the fault volumes, each of the fault populations includes one or more of the faults, and the fault populations are generated by extracting one or more fault objects from one or more of the fault volumes;
generating quantitative values based upon the fault populations, the quantitative values represent on or more of the fault objects, one or more of the fault populations, or both;
comparing the quantitative values to determine the uncertainty of the representation of the fault populations; and
generating a visual representation based upon the comparison.

2. The method of claim 1, wherein the fault populations are generated by extracting two or more different fault objects from one of the fault volumes.

3. The method of claim 1, wherein the fault populations are generated by extracting a first of the fault objects from a first one of the fault volumes, and extracting a second of the fault objects from a second one of the fault volumes.

4. The method of claim 1, wherein the quantitative values include numeric measures of the fault populations, and wherein the numeric measures include a number of the fault objects in each fault population.

5. The method of claim 1, wherein the quantitative values include geometric measures of the fault objects, and wherein the geometric measures include directions of the fault objects, sizes of the fault objects, shapes of the fault objects, or a combination thereof.

6. The method of claim 5, wherein the directions of the fault objects are represented by:
first angles describing vertical dips of the fault objects; and
second angles describing horizontal orientations of the fault objects.

7. The method of claim 1, wherein the quantitative values include topologic measures of the fault objects and the fault populations, and wherein the topologic measures include a connectivity between two or more of the fault objects.

8. The method of claim 1, wherein the quantitative values include seismic amplitudes at locations of the fault objects, and wherein the seismic amplitudes include values of the seismic data along one or more of the fault objects.

9. The method of claim 8, wherein the quantitative values include an image analysis of the seismic amplitudes at the locations of the fault objects, and wherein the image analysis includes values calculated based upon the seismic data gathered along one or more of the fault objects.

10. The method of claim 9, wherein each of the fault volumes is generated using a machine learning (ML) model, and wherein a confidence of the ML model is determined based upon the image analysis.

11. A non-transitory, computer-readable medium storing instructions that, when executed by at least one processor of a computing system, cause the computing system to perform operations, the operations comprising:
receiving seismic data representing a subterranean domain, the subterranean domain includes a plurality of faults;
generating a plurality of fault volumes based upon the seismic data, each of the fault volumes includes one or more of the faults;
generating a plurality of fault populations based upon the fault volumes, each of the fault populations includes one or more of the faults, and the fault populations are generated by:
extracting two or more different fault objects from one of the fault volumes, or
extracting a first one of the fault objects from a first one of the fault volumes, and
extracting a second one of the fault objects from a second one of the fault volumes;
generating quantitative values based upon the fault populations, the quantitative values represent one or more of the fault objects, one or more of the fault populations, or both, and the quantitative values include numeric measures of the fault populations, geometric measures of the fault objects, topologic measures of the fault objects and the fault populations, seismic amplitudes at locations of the fault objects, an image analysis of the seismic amplitudes at the locations of the fault objects, or a combination thereof;
comparing the quantitative values to determine an uncertainty of a representation of the fault populations, comparing the quantitative values includes generating a visual representation of the quantitative values;
displaying the visual representation on a display.

12. The non-transitory, computer-readable medium of claim 11, wherein each of the fault volumes is generated using a different ML model or a different image analysis technique.

13. The non-transitory, computer-readable medium of claim 11, wherein generating the visual representation includes generating a spreadsheet including the quantitative values.

14. The non-transitory, computer-readable medium of claim 11, wherein generating the visual representation includes:
plotting the quantitative values for each of the fault populations on a different plot; and
comparing the different plots.

15. The non-transitory, computer-readable medium of claim 11, wherein generating the visual representation includes plotting the quantitative numbers for different ones of the fault populations on a single plot.

16. A computing system, comprising:
one or more processors; and
a memory system coupled to the one or more processors and including one or more non-transitory computer-readable media storing instructions that, when executed by at least one of the one or more processors, cause the computing system to perform operations, the operations including:
receiving seismic data representing a subterranean domain, the subterranean domain includes a plurality of faults;
generating a plurality of fault volumes based upon the seismic data, each of the fault volumes includes one or more of the faults, and each of the fault volumes is generated using a machine learning (ML) model or using an image analysis technique;
generating a plurality of fault populations based upon the fault volumes, each of the fault populations includes one or more of the faults, the fault populations are generated by:
extracting two or more different fault objects from one of the fault volumes, or
extracting a first one of the fault objects from a first one of the fault volumes, and extracting a second one of the fault objects from a second one of the fault volumes,
each fault object represents a corresponding one of the faults as a set of points from the fault volume in three dimensions, and
the fault objects are extracted after varying one or more parameters,
generating quantitative values based upon the fault populations, the quantitative values represent one or more of the fault objects, one or more of the fault populations, or both, and the quantitative values include numeric measures of the fault populations, geometric measures of the fault objects, topologic measures of the fault objects and the fault populations, seismic amplitudes at locations of the fault objects, image analysis of the seismic amplitudes at the locations of the fault objects, or a combination thereof;
comparing the quantitative values to determine an uncertainty of a representation of the fault populations, comparing the quantitative values includes generating a visual representation of the quantitative values;
displaying the visual representation on a display; and
building or updating a model of the subterranean domain based upon the uncertainty.

17. The computing system of claim 16, wherein the one or more parameters include a cutoff threshold of fault volume values, above which a point is determined to be a point of one of the fault objects, and below which the point is determined not to be a point of one of the fault objects.

18. The computing system of claim 16, wherein the one or more parameters include a radius and a cutoff threshold of planarity for which:
a first plurality of points separated by a distance within the radius, that are aligned along a surface of planarity above the cutoff threshold, are determined to be part of the same fault object, and
a second plurality of points separated by the distance within the radius, that are not aligned along a surface of planarity above the second cutoff threshold, are determined not to be part of the same fault objects.

19. The computing system of claim 16, wherein the one or more parameters include a lower cutoff angle and an upper cutoff angle for which fault objects of direction angles between the lower and upper cutoff angles are extracted.

20. The computing system of claim 16, wherein the one or more parameters include a sector angle and an overlap angle for which overlapping angular sections are defined within a range of angles between a lower cutoff angle and an upper cutoff angle, and fault objects are extracted separately within each of the overlapping angular sections.
